(19) United States
(12) Patent Application Publication
(10) Pub. No.: US 2024/0275076 A1
(43) Pub. Date: Aug. 15, 2024

(54) CONNECTION TERMINAL

(71) Applicant: Yazaki Corporation, Tokyo (JP)

(72) Inventor: Takahiro MATSUO, Shizuoka (JP)

(73) Assignee: Yazaki Corporation, Tokyo (JP)

(21) Appl. No.: 18/644,496

(22) Filed: Apr. 24, 2024

Related U.S. Application Data
(63) Continuation of application No. PCT/JP2022/047149, filed on Dec. 21, 2022.

(30) Foreign Application Priority Data
Jan. 18, 2022 (JP) 2022-005586

(51) Int. Cl. H01R 4/02; H01R 4/48; H01R 43/02

(52) U.S. Cl. CPC H01R 4/023; H01R 4/4821; H01R 4/4848; H01R 43/0207

(57) ABSTRACT

A connection terminal includes: an electric wire connection part to which an electric wire is electrically connected by ultrasonic bonding; and an electric connection part integrated with the electric wire connection part and electrically connected to a mating terminal. The electric connection part includes: a box unit which is bent at bending parts to be formed into a cylindrical shape and into which the mating terminal is insertable; and a spring part disposed so as to be elastically deformable in an inner side of the box unit and brought into contact with the mating terminal. The box unit is provided with an avoidance recess recessed so as to be thinner in thickness than the other portions of the box unit and avoiding interference with the spring part, and the avoidance recess is disposed in the inner side from an inner end positioned on an innermost side of the box unit.

### CROSS-REFERENCE TO RELATED APPLICATIONS

The present application is a continuation of International Application No. PCT/JP2022/047149, filed on Dec. 21, 2022, and based upon and claims the benefit of priority from Japanese Patent Application No. 2022-005586, filed on Jan. 18, 2022, the entire contents of which are incorporated herein by reference.

### TECHNICAL FIELD

The present application relates to a connection terminal.

### BACKGROUND ART

JP H11-345645 A (PTL 1) discloses a connection terminal including an electric wire connection part to which an electric wire is electrically connected, and an electric connection part integrated with the electric wire connection part and electrically connected to a mating terminal. In the connection terminal of PTL 1, the electric wire is electrically connected to the electric wire connection part by ultrasonic bonding.

In such a connection terminal, the electric connection part includes a box unit which is formed in a cylindrical shape by bending at a plurality of bending parts and into which the mating terminal can be inserted, and a spring part which is disposed so as to be elastically deformable in an inner side of the box unit and brought into contact with the mating terminal. The box unit is bent at the plurality of bending parts to form the cylindrical shape, and its shape is held by applying laser spot welding to a part that can be opened.

### SUMMARY

In the connection terminal as disclosed in PTL 1, in order to avoid interference between the box unit and the spring part, it is expected that the box unit is provided with an avoidance recess that is recessed so as to be thinner in thickness than other portions of the box unit. By providing the avoidance recess in the box unit, the box unit and the spring part can be disposed close to each other, thereby making it possible to reduce the connection terminal in size.

However, if the box unit is provided with such an avoidance recess that is recessed so as to be thinner in thickness than the other portions of the box unit, the strength of the box unit is reduced. Therefore, when the electric wire is ultrasonically bonded in the electric wire connection part, it is possible that the box unit is damaged by the vibration of the ultrasonic wave. In addition, depending on the joining material and method of welding for the box unit, the strength for ultrasonic bonding can be insufficient. If the joining material and method of welding are changed to satisfy the strength, the cost becomes high.

It is an object of the present application to provide a connection terminal capable of improving durability against ultrasonic bonding.

A connection terminal according to the present application includes: an electric wire connection part to which an electric wire is electrically connected by ultrasonic bonding; and an electric connection part integrated with the electric wire connection part and electrically connected to a mating terminal. The electric connection part includes: a box unit which is bent at a plurality of bending parts to be formed into a cylindrical shape and into which the mating terminal is insertable; and a spring part disposed so as to be elastically deformable in an inner side of the box unit and brought into contact with the mating terminal. The box unit is provided with an avoidance recess which is recessed so as to be thinner in thickness than other portions of the box unit, and avoids interference with the spring part, and the avoidance recess is disposed in the inner side of the box unit from an inner end positioned on an innermost side of the box unit.

According to the present application, it is possible to provide the connection terminal capable of improving durability against ultrasonic bonding.

### BRIEF DESCRIPTION OF DRAWINGS

FIG. 1 is a perspective view of a connection terminal according to the present embodiment.

FIG. 2 is an expanded plan view of the connection terminal according to the present embodiment.

FIG. 3 is an enlarged view of a main portion of FIG. 2.

FIG. 4 is a cross-sectional view of the connection terminal according to the present embodiment.

FIG. 5 is an enlarged perspective view of a main portion of FIG. 4.

FIG. 6 is a cross-sectional view of the connection terminal according to the present embodiment.

### DETAILED DESCRIPTION OF EMBODIMENT

Hereinafter, a connection terminal according to a present embodiment will be described in detail with reference to the drawings.

A connection terminal 1 according to the present embodiment is received in a housing (not illustrated), for example, and constitutes a connector. The connector is fitted with a mating connector with a mating terminal received in a mating housing. By fitting the connector with the mating connector, the connection terminal 1 and the mating terminal are electrically connected.

Although not illustrated, the mating terminal is electrically connected to a wire by crimping or the like, for example, to a terminal part of the wire electrically connected to a power source or a device. The mating terminal is provided with a tab-like mating connection part extended along a mating direction between the connector and the mating connector. The connector and the mating connector are fitted, so that the mating connection part is inserted into an electric connection part 5 of the connection terminal 1 and the mating terminal is electrically connected to the connection terminal 1.

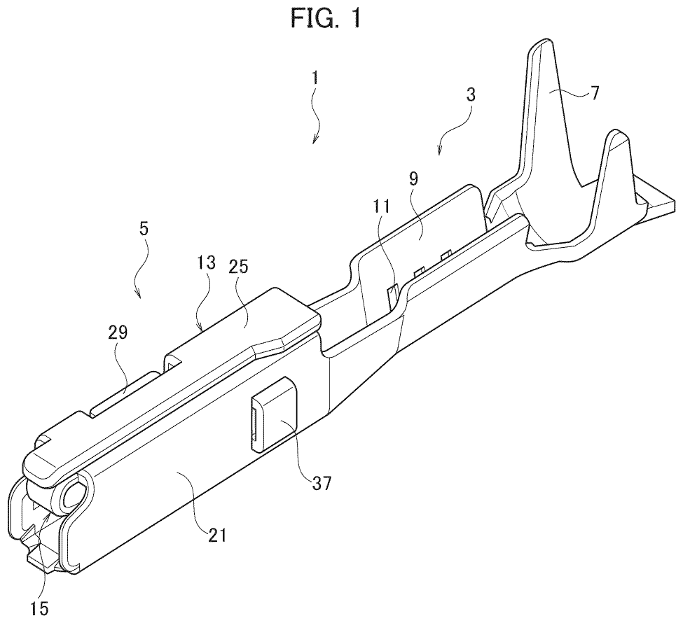

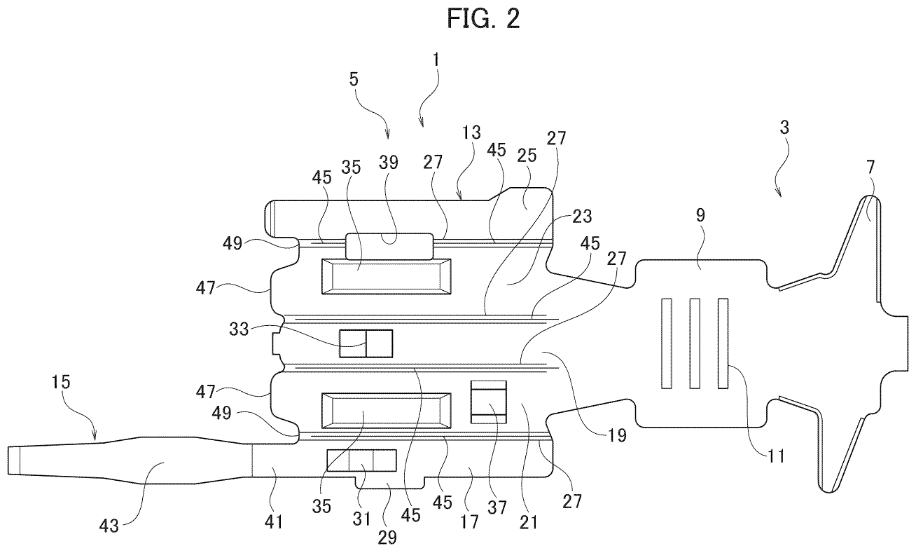

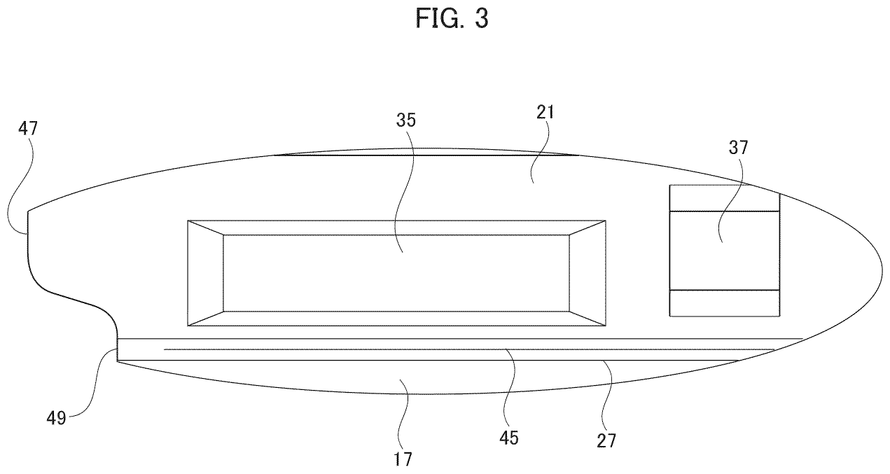

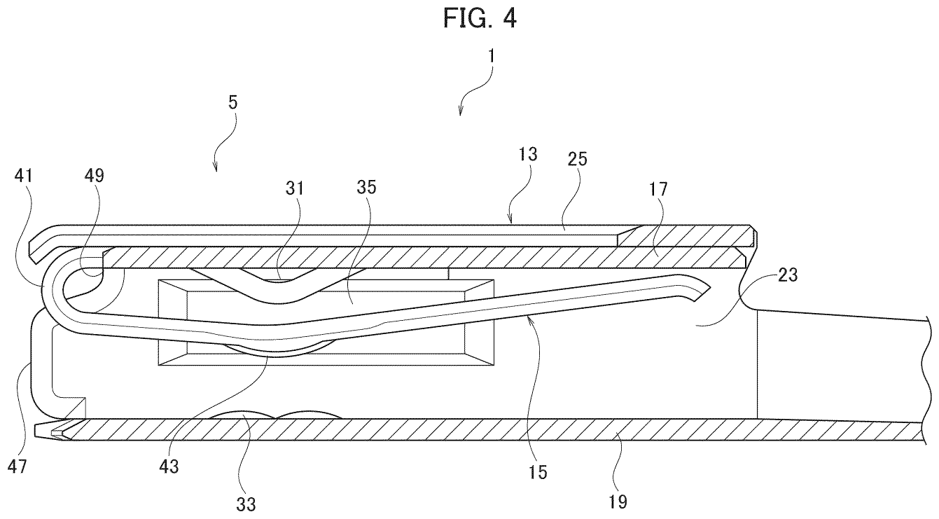

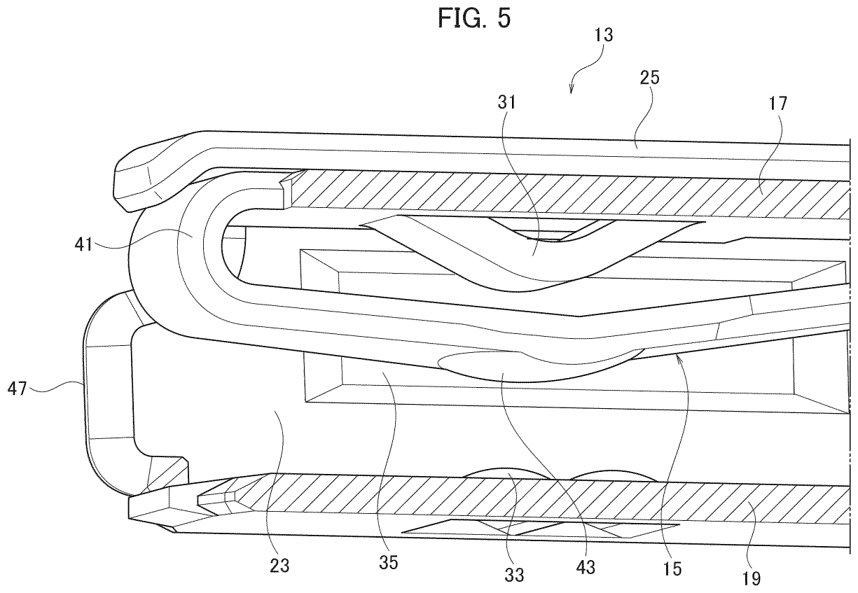

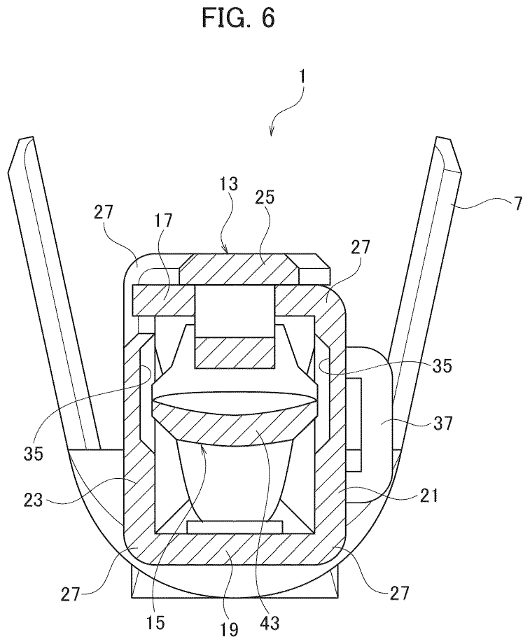

As illustrated in FIGS. 1 to 6, the connection terminal 1 is formed by punching and bending a sheet made of a conductive material. The connection terminal 1 includes an electric wire connection part 3 and an electric connection part 5.

The electric wire connection part 3 includes a covering crimping part 7 and a core wire crimping part 9.

The covering crimping part 7 includes a pair of clamping pieces. The covering crimping part 7 clamps a covering part of an electric wire, for example, at a terminal part of an electric wire (not illustrated) electrically connected to a power source or a device. By clamping the covering crimping part 7 to the covering part of the electric wire, the connection terminal 1 is fixed to the electric wire.

The core wire crimping part 9 consists of a pair of crimping pieces provided between the electric connection part 5 and the covering crimping part 7. A plurality of serrations 11 are formed on an inner surface of the core wire crimping part 9 to destroy an oxide film formed on a core wire part of the electric wire. In the core wire crimping part 9, the core wire part exposed from the covering part of the electric wire is crimped by ultrasonic bonding at a terminal part of the electric wire. By crimping the core wire crimping part 9 to the core wire part of the electric wire, the connection terminal 1 is electrically connected to the electric wire.

The electric connection part 5 includes a box unit 13 and a spring part 15.

The box unit 13 is formed of a member in which a first wall part 17, a second wall part 19, a third wall part 21, a fourth wall part 23 and a fifth wall part 25 are continuously provided, and is formed into a rectangular cylindrical shape by performing bending at a plurality of bending parts 27. In the following, the positional relationship among the first wall part 17, the second wall part 19, the third wall part 21, the fourth wall part 23 and the fifth wall part 25 will be described as an example in this embodiment, but is not limited thereto.

The first wall part 17 is an upper wall arranged on an upper side in a height direction of the box unit 13. One side of the first wall part 17 in a width direction is connected to the third wall part 21 through the bending part 27, and the other side in the width direction is not provided with anything and opened. On the other side of the first wall part 17 in the width direction, a fixing projection 29 is formed by a protrusion outward in the width direction. On the first wall part 17, a regulating projection 31 for regulating excessive deformation of the spring part 15 is formed by a protrusion toward the inside of the box unit 13.

The second wall part 19 is a bottom wall arranged on a lower side in the height direction of the box unit 13. One side of the second wall part 19 in the width direction is connected to the third wall part 21 through the bending part 27, and the other side in the width direction is connected to the fourth wall part 23 through the bending part 27. A contact projection 33 that contacts with the tab-like mating connection part of the mating terminal is formed on the second wall part 19 by a protrusion toward the inside of the box unit 13.

The third wall part 21 is a side wall arranged on one side in the width direction of the box unit 13. One side of the third wall part 21 in the height direction of the box unit 13 (in the width direction of the third wall part 21) is connected to the first wall part 17 through the bending part 27, and the other side in the height direction of the box unit 13 (in the width direction of the third wall part 21) is connected to the second wall part 19 through the bending part 27. In the third wall part 21, an avoidance recess 35 for avoiding interference with the spring part 15 is formed so as to be recessed in such a way as to be thinner in thickness than the other portions of the box unit 13. On the third wall part 21, a prevention projection 37 is formed by a projection toward the outside of the box unit 13. If the connection terminal 1 is inserted into the housing of the connector in an incorrect posture, the prevention projection 37 interferes with the housing to prevent the erroneous insertion of the connection terminal 1 into the housing.

The fourth wall part 23 is a side wall which is disposed on the other side of the box unit 13 in the width direction, and is disposed opposite to the third wall part 21. One side of the fourth wall part 23 in the height direction of the box unit 13 (in the width direction of the fourth wall part 23) is connected to the second wall part 19 through the bending part 27, and the other side in the height direction of the box unit 13 (in the width direction of the fourth wall part 23) is connected to the fifth wall part 25 through the bending part 27. In the fourth wall part 23, the avoidance recess 35 for avoiding interference with the spring part 15 is formed so as to be recessed in such a way as to be thinner in thickness than the other portions of the box unit 13.

The fifth wall part 25 arranged on the upper side in the height direction of the box unit 13 is a superposed upper wall arranged on the upper side of the first wall part 17. One side of the fifth wall part 25 in the width direction is connected to the fourth wall part 23 through the bending part 27, and the other side in the width direction is not provided with anything and is opened. In the bending part 27 of the fifth wall part 25, a fixation hole 39 is formed through the fourth wall part 23 and the fifth wall part 25. The fixing projection 29 is inserted into the fixation hole 39 in a state that the box unit 13 is formed by bending, so that the shape of the box unit 13 is held. Further, after the box unit 13 is formed by bending, the fifth wall part 25 and the first wall part 17 may be welded and fixed by spot welding or the like.

The electric wire connection part 3 is connected to one end of the box unit 13 in a length direction, and the spring part 15 is connected to the other end of the box unit 13 in the length direction. More specifically, the electric wire connection part 3 is formed of a continuous member at the end portion of the second wall part 19, the third wall part 21 and the fourth wall part 23 in the length direction. The spring part 15 is formed of a continuous member at the end portion of the first wall part 17 in the length direction.

The spring part 15 is connected to the first wall part 17 of the box unit 13 on an end opposite to the electric wire connection part 3 in the length direction. The spring part 15 is bent toward the inside of the box unit 13 through a spring bend 41 to the first wall part 17, and is arranged inside the box unit 13 so that it can be elastically deformed. The spring part 15 includes a contact 43 formed wider than other parts and protruding toward the inside of the box unit 13. The contact 43 is arranged in the avoidance recesses 35 of the third wall part 21 and the fourth wall part 23 inside the box unit 13, so that interference with the third wall part 21 and the fourth wall part 23 due to elastic deformation of the spring part 15 is prevented. By disposing the contact 43 in the avoidance recess 35, the spring part 15, the third wall part 21, and the fourth wall part 23 can be disposed close to each other, thereby making it possible to reduce the box unit 13 in size.

When the connector and the mating connector are engaged with each other, the contact 43 contacts with the tab-like mating connection part of the mating terminal inserted into the box unit 13, so that the spring part 15 is elastically deformed. The elastically deformed spring part 15 makes the contact 43 contact with the mating connection part by an urging force to be restored, so that the connection terminal 1 is electrically connected with the mating terminal. At this time, the spring part 15 which is about to be excessively deformed contacts with the regulating projection 31, preventing excessive deformation, and the contact between the contact part 43 and the mating connection part is maintained. Moreover, the contact projection 33 is brought into contact with the mating connection part inserted into the box unit 13, so that reliability of the electric connection between the connection terminal 1 and the mating terminal can be maintained.

The plurality of bending parts 27 of the box unit 13 in which the spring part 15 is disposed in the inner side is provided with thin-walled portions 45 formed so as to be thinner in thickness than the other portions of the box unit 13 in order to facilitate bending. The thin-walled portions 45 are formed continuously along the bending parts 27, and formed by so-called pressed line. The thin-walled portions 45 are formed, for example, half as thick as other parts of the box unit 13. By providing the thin-walled portions 45 in the bending parts 27, the strength of the bending parts 27 is lowered, so that the bending is easily performed and the workability can be improved. Further, the thickness of the thin-walled portions 45 can be set as appropriate in consideration of the strength and workability of the box unit 13.

In the connection terminal 1, the core wire part of the electric wire is connected to the electric wire connection part 3 by crimping by the ultrasonic bonding. In the ultrasonic bonding, minute vibrations at high speed are generated during bonding. The vibration caused by the ultrasonic bonding greatly influences the box unit 13 of the electric connection part 5 located on the opposite side to the electric wire connection part 3 in the length direction of the connection terminal 1.

An end portion of the box unit 13 opposite to the electric wire connection part 3 include outer ends 47 positioned on the outermost side of the box unit 13, and inner ends 49 positioned on the innermost side of the box unit 13. The outer ends 47 and the inner ends 49 are provided on the third wall part 21 and the fourth wall part 23 constituting the box unit 13. The width between the outer ends 47 and the inner ends 49 is smaller than the other portions of the third wall part 21 and the fourth wall part 23. In order to avoid interference with the spring part 15, each of the third wall part 21 and the fourth wall part 23 is provided with the avoidance recess 35 that is recessed so as to be thinner in thickness than the other portions of the box unit 13. Here, it is assumed that the avoidance recesses 35 are disposed in the outer side of the box unit 13 from the inner ends 49. If the avoidance recesses 35 are disposed in the outer side of the box unit 13 from the inner ends 49, the width between the outer ends 47 and the inner ends 49 is smaller than the other portions of the third wall part 21 and the fourth wall part 23, which reduces the strength in the vicinity of the inner ends 49 in the box unit 13. For this reason, due to the effect of vibration caused by the ultrasonic bonding, there is a possibility that the box unit 13 may be broken from the inner ends 49. Therefore, in the present embodiment, the avoidance recesses 35 are disposed in the box unit 13 so as to improve the durability to vibration caused by the ultrasonic bonding.

Specifically, in the present embodiment, the avoidance recesses 35 are disposed in the inner side of the box unit 13 from the inner ends 49 in the third wall part 21 and the fourth wall part 23 of the box unit 13. The avoidance recesses 35 are disposed apart from the inner ends 49 with a predetermined length. By disposing the avoidance recesses 35 in the inner side of the box unit 13 from the inner ends 49, the thickness of the box unit 13 in the vicinity of the inner ends 49 is maintained, thereby increasing the strength in the vicinity of the inner ends 49. Thus, the durability against the ultrasonic bonding can be improved in the vicinity of the inner ends 49. In particular, the spring part 15 is connected to the first wall part 17, which is connected to the third wall part 21 via the bending part 27, via the spring bend 41. The spring bend 41 is positioned in the vicinity of the inner ends 49. For this reason, by increasing the strength in the vicinity of the inner ends 49, it is possible to suppress the breakage of the spring part 15 due to vibration caused by the ultrasonic bonding, thereby maintaining the electric connection reliability of the connection terminal 1. The spring part 15 may be connected to the second wall part 19. In this case, the avoidance recesses 35 which are provided in the third wall part 21 and the fourth wall part 23 connected to the second wall part 19 via the bending parts 27 are disposed in the inner side of the box unit 13 from the inner ends 49. For this reason, even when the spring part 15 is connected to the second wall part 19, the strength in the vicinity of the inner ends 49 is high, thereby making it possible to suppress the breakage of the spring part 15 due to vibration caused by the ultrasonic bonding. The predetermined length of the avoidance recesses 35 disposed apart from the inner ends 49 can be appropriately set to have durability against the ultrasonic bonding in consideration of the material to be used, the thickness of the material, the thickness of the avoidance recesses 35, the length between the outer ends 47 and the inner ends 49, the length of the box unit 13, the width of the box unit 13, and the like.

The plurality of bending parts 27 is provided with the thin-walled portions 45 formed so as to be thinner in thickness than the other portions of the box unit 13. For this reason, in the box unit 13, the bending parts 27 provided with the thin-walled portions 45 have a lower strength. Thus, the avoidance recesses 35 are disposed at least apart from the thin-walled portions 45 in the third wall part 21 and the fourth wall part 23 of the box unit 13. In the present embodiment, the avoidance recesses 35 are disposed apart from the bending parts 27 with a predetermined length. By disposing the avoidance recesses 35 apart from the bending parts 27, the thickness between the avoidance recesses 35 and the bending parts 27 is secured, thereby increasing the strength in the vicinity of the bending parts 27. For this reason, the durability against the ultrasonic bonding can be improved in the vicinity of the bending parts 27. The predetermined length of the avoidance recesses 35 disposed apart from the thin-walled portions 45 or from the bending parts 27 can be appropriately set to have durability in consideration of the material to be used, the thickness of the material, the thickness of the avoidance recesses 35, the length of the box unit 13, the width of the box unit 13, and the like.

The thin-walled portions 45 are disposed in the bending parts 27 apart from the end portions positioned opposite to the electric wire connection part 3 with a predetermined length. By disposing the thin-walled portions 45 apart from the end portions of the bending parts 27, the strength of the bending parts 27 is increased. Thus, the durability against the ultrasonic bonding can be improved in the bending parts 27. In particular, since the end portions of the bending parts 27 opposite to the electric wire connection part 3 are open far from the electric wire connection part 3, they are largely affected by vibration caused by the ultrasonic bonding. For this reason, by disposing the thin-walled portions 45 apart from the end portions of the bending parts 27 opposite to the electric wire connection part 3, the strength of the end portion of the box unit 13 opposite to the electric wire connection part 3 can be increased, thereby making it possible to effectively improve the durability to vibration caused by the ultrasonic bonding. The thin-walled portions 45 may be disposed apart from the end portions of the bending part 27 positioned on the electric wire connection part 3 side with a predetermined length. The predetermined length of the thin-walled portions 45 disposed apart from the end portions of the bending parts 27 can be appropriately set to have workability and durability in consideration of the material to be used, the thickness of the material, the thickness of the thin-walled portions 45, the length of the box unit 13, the width of the box unit 13, and the like.

The connection terminal 1 includes the electric wire connection part 3 to which an electric wire is electrically connected by the ultrasonic bonding, and the electric connection part 5 integrated with the electric wire connection part 3 and electrically connected to a mating terminal. The electric connection part 5 includes the box unit 13 which is bent at the plurality of bending parts 27 to be formed into a cylindrical shape and into which the mating terminal is insertable, and the spring part 15 disposed so as to be elastically deformable in an inner side of the box unit 13 and brought into contact with the mating terminal. The box unit 13 is provided with the avoidance recess 35 which is recessed so as to be thinner in thickness than the other portions of the box unit 13, and avoids interference with the spring part 15. The avoidance recess 35 is disposed in the inner side of the box unit 13 from the inner end 49 positioned on the innermost side of the box unit 13.

Since the avoidance recess 35 is disposed in the inner side of the box unit 13 from the inner end 49 positioned on the innermost side of the box unit 13, the thickness in the vicinity of the inner end 49 can be secured, thereby making it possible to increase the strength in the vicinity of the inner end 49 of the box unit 13. Thus, the durability of the box unit 13 against the ultrasonic bonding can be improved, thereby making it possible to suppress the breakage of the box unit 13 caused by the ultrasonic bonding. In addition, even when the box unit 13 is welded, an inexpensive bonding material for welding or a simple welding method can be applied to the box unit 13, thereby reducing the costs.

Accordingly, the connection terminal 1 makes it possible to improve the durability against the ultrasonic bonding.

The avoidance recess 35 is disposed apart from the bending part 27. Thus, the thickness between the bending part 27 and the avoidance recess 35 can be secured, thereby making it possible to increase the strength in the vicinity of the bending part 27, and improve the durability of the box unit 13 against the ultrasonic bonding.

The box unit 13 includes the first wall part 17 serving as a spring wall part to which the spring part 15 is connected, and the third wall part 21 serving as a connection wall part which is connected to the first wall part 17 via the bending part 27. The avoidance recess 35 is provided in the third wall part 21. Thus, by increasing the strength of the third wall part 21 adjacent to the spring part 15, it is possible to suppress the breakage of the spring part 15 caused by the ultrasonic bonding, thereby making it possible to maintain the electric connection reliability.

The bending part 27 is provided with the thin-walled portion 45 formed so as to be thinner in thickness than the other portions of the box unit 13. Thus, the strength of the bending part 27 can be reduced, thereby making it possible to improve the workability of the box unit 13. The avoidance recess 35 is disposed apart from the thin-walled portion 45. For this reason, the avoidance recess 35 and the thin-walled portion 45, which are formed so as to be thinner in thickness, are not continuous with each other, and the thickness between the avoidance recess 35 and the thin-walled portion 45 is secured, thereby making it possible to increase the strength of the box unit 13. Thus, the thin-walled portion 45 is provided in the bending part 27 to improve the workability of the box unit 13, and the durability of the box unit 13 against the ultrasonic bonding can be improved.

Although the present embodiment has been described above, the present embodiment is not limited thereto, and various modifications are possible within a scope of the gist of the present embodiment.

For example, the connection terminal 1 according to the present embodiment is electrically connected to the mating terminal by fitting the connector to the mating connector, but not limited thereto. A direct electric connection between the connection terminal 1 and the mating terminal is also possible.

The box unit 13 is formed in a rectangular cylindrical shape, but not limited thereto. The cylindrical shape of the box unit may include any shape, such as a hexagonal cylindrical shape or other polygonal cylindrical shape.

The avoidance recess 35 is provided in each of the third wall part 21 and the fourth wall part 23, but not limited thereto. The avoidance recess 35 may be provided only in the third wall part 21, or in the fourth wall part 23.

The spring part 15 is integrally connected to the first wall part 17 via the spring bend 41, but not limited thereto. The spring part 15 may be formed separately from the box unit 13, and the spring part 15 may be disposed in the inner side of the box unit 13.

1. A connection terminal, comprising:
an electric wire connection part to which an electric wire is electrically connected by ultrasonic bonding; and
an electric connection part integrated with the electric wire connection part and electrically connected to a mating terminal, wherein
the electric connection part comprises a box unit which is bent at a plurality of bending parts to be formed into a cylindrical shape and into which the mating terminal is insertable, and a spring part disposed so as to be elastically deformable in an inner side of the box unit and brought into contact with the mating terminal,
the box unit is provided with an avoidance recess which is recessed so as to be thinner in thickness than other portions of the box unit, and avoids interference with the spring part,
the avoidance recess is disposed in the inner side of the box unit from an inner end positioned on an innermost side of the box unit,
the plurality of bending parts is provided with thin-walled portions formed so as to be thinner in thickness than the other portions of the box unit, and
the thin-walled portions are disposed in the bending parts apart from the end portions positioned opposite to the electric wire connection part with a predetermined length.

2. The connection terminal according to claim 1, wherein the avoidance recess is disposed apart from the bending parts.

3. The connection terminal according to claim 1, wherein
the box unit comprises a spring wall part to which the spring part is connected, and a connection wall part connected to the spring wall part via one bending part, and
the avoidance recess is provided in the connection wall part.

4. The connection terminal according to claim 1, wherein
the avoidance recess is disposed apart from the thin-walled portions.
